(19) United States
(12) Patent Application Publication
(10) Pub. No.: US 2017/0324711 A1
(43) Pub. Date: Nov. 9, 2017

(54) Method for establishing, securing and transferring computer readable information using peer-to-peer public and private key cryptography

(71) Applicant: THE REAL MCCOY, LLC INC., STAMFORD, CT (US)

(72) Inventors: Patrick Feeney, Stamford, CT (US); Douglas Scott Eads, Sherman Oaks, CA (US)

(73) Assignee: THE REAL MCCOY, LLC INC., STAMFORD, CT (US)

(21) Appl. No.: 15/145,537

(22) Filed: May 3, 2016

(51) Int. Cl. H04L 29/06; H04L 9/30

(52) U.S. Cl. CPC H04L 63/0428; H04L 9/30; H04L 2209/56

(57) ABSTRACT

System and method for confirming and transferring information from one party to another via block chain escort, using central and decentralized databases acting as online storage providers. Files are linked to cryptographic currency structures comprised of a public and private key identification processes. Locking, unlocking, retrieving, storing, confirming and transferring files requires linked association to block chain protocol measures of crypto-currency processes.

Establishing file space requires that the owner links it to a centralized or decentralized peer-to-peer cryptographic block chain protocol. This secures and locks files for subsequent confirmation and transfer. Confirmation and transfer of the file is processed with a cryptographic hash function of crypto currency block chain process. The system and method requires that the transferee obtain the file using crypto currency transfer protocol. The system and method associates a piece of information with a public key and private keys, which are accessed only by the owner.

### RELATED APPLICATIONS

This application claims the benefit of priority of U.S. Provisional Patent Application No. 62/156887 entitled “METHOD FOR ESTABLISHING, SECURING AND TRANSFERRING COMPUTER READABLE INFORMATION USING PEER-TO-PEER PUBLIC AND PRIVATE KEY CRYPTOGRAPHY” filed May 4, 2016, the entire contents of which are hereby incorporated by reference for all purposes.

### BACKGROUND

Computer users of any stripe may create files which contain all manner of information. These files may be stored in in the respective device itself, be it mobile or stationary. Files may be stored and accessed via cloud created infrastructure which therefore enables all manner of mobile file sharing and transferring capability. Some of this information is deemed by the user to be sensitive and whose contents must be secured in a virtual lock box the access of which may only be made upon request and upon the subsequent approval of the owner. Currently such highly sensitive information may be stored in hardcopy form and kept in a safe or a safe deposit box. It may be kept in a highly secure cloud database or in a username/password established personal computing database. Under current “cloud” storage frameworks security concerns limit the ability of the user to keep highly sensitive valued information for subsequent transfer. As cloud computing proliferates, security of sensitive personal files are increasingly being left in the hands of a third party provider; the owners/administrators of the respective cloud storage databases.

Presently, Transport Layer Security (TSL) and its predecessors Secure Socket Layer (SSL), pretty good privacy (PGP), public key infrastructure (PKI), privilege management infrastructure (PMI), Advanced Encryption Standard (AES), Signed Public Key and Challenge (SPKAC), Online Certifications Status Protocol (OCSP), and Multi-Factor Authentication (MFA) or Authentication (2FA/3FA) protocols technologies and systems exist in order to help the internet function by digitally securely. They act as trust anchors or chains of trust, and are known to be issued by certification authorities. All of the above providers however, function as third party security measures. Once information is provided, the original purveyor of the information essentially hands over all of his/her control of the content and security of said stored information to a third party infrastructure.

It is the aim of the present invention to disclose a method for the original purveyor of information to have the means to hold the security of said information in his/her control. He/she may then transfer of said information at his/her discretion and do so with traceability and accountability that is linked to the security functionality of current crypto-currency block chain protocols.

Some instruments can be stored, uploaded, transferred and reproduced in physical form and used in practice as a functioning copy of the original. The instrument can be used legally like the original. By way of an example, information stored for the eventual reproduction and use for a physical key is currently available and legally allowed under the law. 20130173044 A1 teaches a system and method for duplicating keys by creating them purely from metrics stored in information-based computer files. A hardware processor receives security information from a user. It then receives geometric information about a first key associated with the security information from a storage device. A key shaping device creates a second key using the geometric information. This key is a duplicate that is equal in every respect to the original and can be used as such.

Prior art exists which relates directly with the storage of information derived data using peer-to-peer cryptographical methods. Patent application 20150006895 describes a distributed network system wherein a computer-implemented method of storing data is laid out. A first node on a peer-to-peer communications network is provided in a protected form, the first node data is obfuscated by splitting the first node data into a plurality of data chunks. The protected form of the first node is generated by swapping data between the data chunks and encrypting the data chunks by applying an encryption algorithm. The protected form of the first node is then stored on the peer-to- peer communications network. A public and private key pair from the first node data is then created and assigned a hash value for the public key as an identifier for the user of the node.

This application however, describes an entire network for storing data by creating a new virtual storage space that acts as an alternative to current hard disks and/or distributed systems which store data in cloud format via Internet data management providers. While this network is built upon peer-to-peer cryptocurrency principals, it does not leverage existing crypto-currency infrastructure. It fails to disclose a method of establishing, storing, securing and then transferring of information to third party recipients of the customer's choosing.

It is not the aim of the present invention to disclose an entire network of information storage which is based on cryptographic currency technology. Rather the aim is to provide a specific method for a purveyor of information, (who desires heightened security and traceability of said information), to securely upload it onto a central database and have the means to hold the security of said information in his/her control so that any subsequent transfer can be accomplished using peer-to-peer audited block chain protocol. He/she may transfer said information at his/her discretion and do so with traceability and accountability that is linked to the security functionalities of current crypto-currency block chain protocols.

Counterfeiting laws limit the ability to reproduce certain types of instruments. Thus in certain circumstances, only an original document is allowed to pass for the purposes of official use. Examples include but are not limited to bank issue money orders, cashier's checks and the like. As cryptographic techniques improve and as online cybersecurity affords users the ability to create a digital file, secure that file, and recreate it with 100% confidence in its validity it is possible that the regulatory landscape will change to accommodate these technological advantages.

The list below is not intended as an exhaustive list of information derived machine reproducible instruments. Nor does it distinguish which instruments can and cannot be legally reproduced with the same authenticity of the original. It merely describes the type of sensitive information capable of being stored, established, confirmed and transferred to an interested third party using novel cryptocurrency-based block chain protocol techniques herein described.

Examples of such information include:

1. Information-based files capable of being transformed into reproducible tangible items. Physical “keys” or “transponders”; items that unlock vehicles, doors, security systems, safe deposit boxes, safes, & storage facilities are examples of such physical items capable of reproduction using purely information-based computer files. These keys/transponders are regularly used in gaining physical access to vehicles, houses, boats, motorcycles, Medeco® locks, keyless entry door locks, digital door locks, real estate buildings, locking mailboxes, & work related buildings.

2. Information-based reproducible pieces of digital instruments whose title is deemed to be owned by the bearer. Bearer instruments have no official records which are kept of who owns the underlying property, or of the transactions involving transfer of ownership. Bearer instruments capable of reproduction using purely virtual information stored in computer file format include but are not limited to the following:
Bearer bonds
Lotteries stubs
Scratch cards
Token money

3. Information-based units produced via 3d-printed consoles (i.e. printed in 3 dimensions). It may be possible to reproduce a sculpture or a piece of furniture or a functional piece of home wear such as a glass or a kitchen utensil using 3d animated printing technology derived purely from computer-based information files whose input is capable of a tangible output created by an additive manufacturing 3D-capable industrial robot. Such 3D printed units may in the future be subject to utility patent, trade dress and or design patent protection.

5. Information-based projective geometry wherein geometrical formulae can be created and stored for eventual reproduction in cyberspace:

Body scans used for fashion and/or law enforcement purposes. Backscatter technology used to create virtual X-ray-derived recreations of physical bone structures of individuals for purposes of forensic criminal investigation or simply for custom fitting garments.

Home/property ownership square footage and/or acreage assessments.

3-D reproductions of vehicle, home, personal property (and the like) damage assessments for purposes of insurance awards.

6. Unique search by song records such as found on popular commercial streaming music services such as Spotify®, Pandora®, Grooveshark® and the like.

7. Information-derived reproducible financial and insurance-based official document:

Appraisals

Validated photos used for insurance claims (e.g. insurance photos for claims)

Vehicle damage

Official government issued income tax return statements

Official bank issued personal bank statements

Electronically derived credit card statements

Official bank issued financial instruments such as certificates of deposit, money orders, cashier's checks, promissory notes, loan documentation

Mortgage documentation

Contracts for Financial Instruments (i.e. collateralized mortgage obligations, collateralized bond obligations, swaps, customized futures and options)

Official private accounting statements such as balance sheet accounts, income statements and cash flow statements. Associated Micro Accounting statements such as portions of balance sheets, income statements, cash flow statements, debit, and credit entries.

Sensitive credit and debit banking card information such as debit and credit card numbers, pre-paid card numbers, gift card information and the like

Certifying contents of a safe deposit box as well as certification processes that confirm ownership of lost or stolen items and the like.

8. Information derived machine reproducible official documentation for real property such as title deeds for housing, vehicles and the like.

9. Information derived machine reproducible legal contract instrumentation such as wills, trusts, healthcare proxy statements, power of attorney, “do not resuscitate orders”

10. Confidential legal wrappers such as pending unpublished patent documentation, trademark prosecution materials, any and all other attorney/client privileged work product documentation, deposition, affidavits. Trademark and/or copyright protected Information-based artwork such as artist owned digital media, which would otherwise be easy to reproduce using modern digital computers. For example, copies of a digital image artwork are indistinguishable from original digital image artwork. As a second example, copies of digital video artworks are also indistinguishable from the original. Copyright protected digitally-derived master music recordings.

11. Information derived machine reproducible education documentation which is otherwise subject to authentication requirements. Examples include but are not limited to transcripts, grants, scholarship documentation, and standardized testing scores and reports, take home exam submissions, attendance records, diplomas, school entrance application submissions, school administered job application packets and the like.

12. General information derived machine reproducible documentation that is of value sensitive to the owner and whose ownership authenticity is of importance. Examples of such documentation includes but is not limited to trade secrets (recipes, business methods, privately held technological advancement information, scientific lab reports, formulae, blueprints, etc.), purchase receipts, coupons and the like.

13. “Auto Command”/“Digital Alerts” and “Autofills”. Sensitive personal information is often kept in personal computing devices which allow for quick and easy “autofill” fill-in with respect to the filling out of online forms. Third party service providers often keep such “autofill” information within their own respective databases.

The idea of holding a piece of sensitive information in a computer storage space is important for the party that owns it. It may also be relevant to any government and/or non-government authorities wishing to maintain authenticity of the instrument at issue. If the user cannot establish ownership, confirm ownership, or transfer ownership or display its contents in machine reproducible duplication format then it is difficult to justify spending the money, time and energy it takes to establish and confirm such information in a centralized computer storage space for future duplication, reproduction and transfer. The idea of having ownership of a computer file containing sensitive information capable of machine derived reproduction is important to the original owner. Once created either by or for the owner, the owner wants to be able to confirm and report to interested third parties that he/she is in fact the original owner of the machine reproducible information. Agents of the owner who may be authorized to act on the owner's behalf must also have this power in his/her hands in order to act in an official capacity on the owner's behalf.

In the pre-internet-enabled computer environment era and information-derived machine reproducible transformation of information in duplicate form, it was relatively easy to establish, confirm and transfer items or sensitive documentation. In this era pieces or documentation were difficult to reproduce because it would have been impossible to do so without undue effort. Technology existed to prevent counterfeiting such as creating paper embedded with structures that make reproduction exceedingly difficult. Legal structures existed to authenticate signatures and confirm a document's status as something which can be independently assessed as original and official. Examples include but are not limited to notary signings, signings which were vouched for by witnesses, handwriting forensics, and official stamping practices.

In the present era the idea of keeping, establishing confirming and transferring machine reproducible sensitive information, the idea of ownership authenticity and security all become serious issues. This is because reproductions of information derived machine reproducible physical items and documentation are indistinguishable from originals and can be replicated ad infinitum with exact or near exact specification as the original. Therefore storage of this information by the owner is of utmost importance. The transfer of this information to a specified third party in a way that is secure, confidential and un-hackable is also of utmost concern. Without such safeguards, there is little or no mechanism to establish where the original piece came from. Second, there is little or no mechanism to track the authenticity needed to create an official transfer of sensitive information.

In the past such sensitive information would be kept in a safe deposit box perhaps at home, in the office or in a centralized location such as a bank. Today, much of this type of information is being stored in computer data file format. There is a need for special systems and procedures to be created in order to ensure that sensitive information derived machine reproducible files be kept in cyberspace so that establishing ownership, confirming contents and transferring contents can be accomplished with the utmost discretion and security.

As described above new technologies such as 3D scanning and printing or the reproduction of physical keys gives higher exposure to the owner for breach of security than was before possible. Even worse, new digital based information which can be machine reproduced in a form identical to the original creates a need to establish a system where original ownership, chain of title, storage and transfer can all be tracked with security.

Taking machine reproducible physical keys as an example, a problem arises when a person who would normally be authorized to enter or use the property protected by a lock does not have physical access to the appropriate key. Being able to recover the information needed to recreate and deliver such a key to the owner in need is rife with security issues. US 20130173044 A1 teaches a system and method for duplicating keys and delivering them to their rightful owner in times of need. The process is technologically savvy and done using owner information derived machine reproducible content. However, the ownership and security of such content is suspect. The owner of the key who wishes to employ this system and method for duplicating and delivering a key is required to give the service provider unfettered access to the information. Safeguards are in place which encrypt the information. But these safeguards are in the hands of the service provider. Once given, the original owner of the information behind reproducing the key loses his or her ability to personally account for its security.

Therefore, there is a need for mechanisms for establishing storage, affirming original ownership, assigning and/or transferring said information to a third party without the original owner ever losing personal account and control of his/her sensitive information.

In summary traditional approaches to establish, affirm and transfer true ownership of information derived machine reproducible computer files have major flaws. These flaws hinder the ability of the owner to keep, sell or otherwise transfer such contents in cyberspace to willing third parties interested in obtaining it.

### SUMMARY OF INVENTION

The aim of this disclosure is to overcome these issues, with trustworthy approach for a user to establish ownership, upload sensitive information in a decentralized or centralized database, and affirm ownership once inside this space and transfer contents and/or ownership of contents to a specified third party with un-hackable security functionalities.

The disclosure is summarized as follows. The main idea is to establish ownership of a particular chosen piece of information derived machine reproducible content by providing it with a Bitcoin or other cryptocurrency address. This file is inextricably linked therefore to whichever block chain protocol associated with the underlying currency. Whichever underlying currency this happens to be, the financial footprint of the file is so infinitesimally small that it has no monetary significance other than the fact that it is micro-quantifiable and therefore beholden to the rules and inherent cryptographic security which allow for the cryptocurrency itself to exchange peer-to-peer in cyberspace for value.

Using Bitcoin as an example, a Satoshi is the smallest fraction of a Bitcoin that can currently be sent: 0.00000001 BTC, that is, a hundredth of a millionth BTC. In the future, however, the protocol may be updated to allow further subdivisions, should they be needed. Currently, unspendable transactions are placed on the block chain using OP_Return/UTXO, placed on the block chain and thus confirmed by the minors for a small fee of 1,000 Satoshis. One can embed in their process any amount of Satoshis necessary to keep miners engaged, but this is a minimal cost to keep miners engaged. Thus in this example, one Satoshi can be allocated to one computer file wherein the user desires to utilize the systems of the present disclosure. Thus a tiny sum of Satoshis (micro-units of Bitcoin of such small value that it is monetarily insignificant) can be linked to said file of interest and used to establish ownership of it. Thereby allowing for secure un-hackable storage upload in a decentralized or centralized database.

Affirming ownership of the file and transferring its content (or its ownership itself) to a specified third party can then be done in the same way that Bitcoins are transferred in today's market.

This process is however, not without potential for block chain slowdown issues. Unspendable transactions (such as those intended to act as markers for the current disclosure) have been described as the cause of “block chain bloat” in that these Bitcoin microtransactions which individually need verification create “spam” on the protocol thereby slowing it down. These issues have been dealt with by hashing a plethora of items, compiling those items into one digest and then inserting that digest (which holds many items) to the block chain as a single larger unit. Miners may confirm this digest and keep the internal peer-to-peer audit system working with efficiency. While the present invention speaks to the current standard in the industry with regard to block chain protocol, it is anticipated that numerous ways and means are available or will be available in the future regarding the avoidance of block chain bloat. Some of these include:

Cloning or pre-mining one's own coin and giving it specifics of size concerning the unspendable transactions.

Utilizing coins such as MasterCoin, NXT, Etherium, Dogecoin, Litecoin, Peercoin and the like which do not experience the same block chain bloat issues at Bitcoin currency.

Utilizing vanguard technology such as “married wallets” wherein joint control is established between a user's wallet and a third party service that evaluates logic and real world conditions (known as an ‘oracle’).

Currently the block chain's OP_Return.UTXO function(s) allow for only a possible maximum of 80 bytes. Given the file sizes provided by the present disclosure “markers” will be used, (until the block chain's capacity expands), to identify what in all likelihood a much larger file. We intend to expand as the size of the bitcoin block chain's unspendable transaction amount expands. Thus the “marker” is by association just an identifier of a virtual safe box whose contents include by association a way to point to the larger file. The marker itself is an alpha-numeric public/private key audited for accuracy via block chain protocol measures described above and consolidated via the hashing of many items in one digest for block chain insertion.

The present disclosure accounts for the potential of the block chain protocol to accept much larger file sizes thereby not requiring a “marker” entry system. However, at present “block chain bloat” issues require the aforementioned a “marker” identification system. The file that the “marker” identifies may be stored in a central or a de-central location; in a cloud, in an email, in a text or in some other shared internet enabled mechanism.

That is to say the transfer of Bitcoins (or any crypto-currency which uses block chain protocol methodologies) from one party to another done by means of the block chain protocol acts as the underlying marker for the transfer of content of the file that the owner originally wished to have uploaded and established as a secure file in a central database capable of marking and confirming ownership of said file using a micro-fraction of cryptocurrency as an identifying linking member. Transfer of said file is thus achieved by means of the cryptocurrency block chain protocol that underlies the regular procedures for money transfer for that respective cryptocurrency. By using the online service's transfer protocol; for example in Bitcoin, transferring funds from the previous Bitcoin address to a Bitcoin address B owned by a new owner; defines the owner of B as the receiving party of the linked computer file. Thus the ability to secure the file and keep it under virtual lock and key possession by the original owner may be done in cyberspace with the same un-hackable insurance as is synonymous with the cryptocurrency itself. Subsequently the ability to send and track the sensitive information from the owning party to the receiving party may be done with un-hackable security synonymous with the block chain protocol that underlies the cryptocurrency transfer procedure itself.

The owner of the public ID (the cryptocurrency stamped account filled with micro- quantities of said cryptocurrency) is by definition the owner and possessor of the file at issue. Therefore a single owner of the original file is stamped by a cryptocurrency linkage as possessor of a virtual lockbox in cyberspace. That lock box acts as a safe deposit box held in a centralized or decentralized database but whose contents can only be opened, confirmed, affirmed and transferred by means of cryptocurrency associated block chain protocol and the users ID. Thus by extension the trustworthiness of files kept in such a centralized or decentralized database herein disclosed is by association as secure and un-hackable as the underlying cryptocurrency itself. This enables secure ‘single owner’ kept files held in a manner which establishes such ownership, affirms such ownership and transfers such ownership of information derived machine reproducible computer files.

Because cryptocurrency transfers are done peer-to-peer with the ironclad security of the block chain protocol, the present disclosure provides a desirable level of anonymity and ownership to the file that this cryptocurrency micro-unit is linked. Owners of the file who upload it into the present centralized database can remain anonymous if they choose. If or when they choose to demonstrate to an interested party that they own a piece, they only need to demonstrate to interested parties that they can control the public ID (i.e. the cryptocurrency address associated with the file). Extra benefits may arise depending on the nature of the service. For example, with Bitcoin, if the original Bitcoin address associated with the artwork is made publically available, (since all Bitcoin transactions are publicly available via Bitcoin Block chain, which is a secure master list or ledger (electronic ledger) of all Bitcoin transactions), then the Bitcoin address currently associated with the stored compute file can always be determined. Chain of title for the original transfer of that document is therefore known and verifiable with the utmost certainty.

Transfer of sensitive information once it is loaded and locked in the block chain may occur in a host of ways. Sending a file may be done using input measures that occur at the independent discretion of the customer. Or the customer may choose that that his/her information upload be pre-determined to automatically release upon the occurrence of a particular event. For example a geo-fencing feature in a software program that uses the global positioning system (GPS) or radio frequency identification (RFID) to define geographical boundaries may trigger a release of the sensitive information as soon as a vehicle, an object or a person breaches or enters the barrier.

Delivery of information may also be done in a host of ways. If the information that is transferred requires physical reproduction (i.e. a hardware device), the service provider may a lot a particular member location that is capable of printing the sensitive information in hardcopy format. The location chosen may be one that has the most geographic benefit for the party who wishes to receive it. GPS coordination technology or geo-fencing will be incorporated in order to facilitate transfer and delivery of the sensitive information at issue which requires hardware based reproduction. A user may choose to send a hardcopy of his/her own sensitive machine reproducible information and have it delivered based on his/her own coordinates at the time. Or a user may elect to transfer it to a 3rd party transferee and so so by sending the machine reproducible information to a hardware enabled location best suited to the location of the transferee-based upon the latter's GPS positioning at the time. Of course if the sensitive information is strictly virtual in nature and requires no physical reproduction, no hardware reproduction is required and the information may be released from the user's internet enabled device to the desired internet enabled device of the transferee.

### DETAILED DESCRIPTION OF PREFERRED EMBODIMENTS

In detail the flow consists of the user independently obtaining a machine reproducible information derived file. The file need not have been created by the user; it may have been acquired by the user or converted for the user by the original owner or an expert in the space. Described below is a method for securely storing, establishing, confirming and transferring an instrument from one party to another. A bearer instrument is used only as an example that best illustrates the usefulness of the present invention. In fact the following method may be applied to any information-based digitally reproducible instrument.

Customer will optionally provide a bearer instrument to a third party service provider. Bearer instruments are documents that gives the owner title to the instrument by the simple fact of possession of the instrument. In the present invention any physical item such as a subway swipe card or a lottery ticket or objects like keys can be securely stored and retrieved as long as it is possible to digitize its characteristics. With bearer instruments no records are kept of who owns the underlying property, or of the transactions involving transfer of ownership. With any important document, especially bearer instruments, ownership is extremely difficult to recover in the event of loss, theft, or damage. Our invention ensures establishing ownership by allowing the customer to store, retrieve, delete, send, and transfer title of documents and tangible objects.

Examples of bearer instruments are documents in Word or pdf format. Physical objects are represented by a mathematical or geometric code. For example one will scan the image of the physical key and using software turn that key's characteristics such as biting patterns into a mathematical/geometrical code that can be stored as an electronic file. This file can be sent, received, transferred to another user for replication. The invention is not restricted to keys. Any physical three dimensional object is capable of being scanned and converted into a mathematical/geometric code with commercially available software can be electronically stored; sent and retrieved securely using our invention.

When the software on the computing device has scanned the necessary information to allow for replication it will be stored as one or several of the following a: hypertext file, text file, text based semi-graphics, binary file, JGeometry method in Java, vector graphics or vector file, pixel-based graphics, digital imaging scanning, rastor graphics or scanning (.GIF/.JPEG/.PNG/MS Paint/GIMP/PhotoShop/Painter/Painter.NET), bitmapped displays (aka rastor imaging processing), dots per inch (DPI), pixels per inch (PPI), geographical information systems (GIS) file formats, such as manifolds in computer graphics, vector digital elevation model file (Adobe Illustrator, Inkscape, Xfig, CoreIDRAW), spatial data management systems (DBMS) file, geometric or mathematical file (i.e. MatLab), multi-image file for layering, a/.doc/.pdf/.xls/or any suitable and appropriate file. This “file”, in the case of a physical key, containing the biting information, key type (i.e. whether plastic or not), “blank” type, and other replication identifiers of the information is now a digitally transportable “file” that is encrypted.

Instructions are provided to the customer to generate a public and private key using a service like bitaddress.org or creating our own. The customer has the option not to disclose the private key to us. In the following action an account is created in a decentralized or centralized network similar to a cryptocurrency wallet provider-type of entity. This wallet provider is uniquely configured such that the cryptocurrency it holds on the owner's behalf is linked to individual packets of storage space capable holding in a database sensitive computer files that the owner desires to have kept for the purposes of eventual transfer to a desired third party. Thus the desired computer file gets associated with the unique cryptocurrency address kept with public and private key security measures.

The hardware and software reads a digital computing file that allows for virtual currency cryptography to lock and unlock this stored information inside its “file”. This file and its owner's variables is stored directly on the block chain if it is no larger than 80 bytes because the block chain has limitations on the amount of bytes, remedies discussed above, it can accept for purely unspendable transactions. We will post directly to the block chain file sizes that can fit inside the block chain via the OP_RETURN/UTXO functions. We use SHA 256 protocol that creates a digest in the bitcoin block chain via the OP_RETURN script. This is a bitcoin scripting opcode that marks the transaction output as provably unspendable and allows a small amount of data to be inserted which in our invention is the hashed file if it is less than 80 bytes or an identifier marker that points to the actual file. A 40 byte sequence more than suffices to encode the marker with an embedded hash value that this invention uses for larger files This value can uniquely represent any digital document, from an image, to a poem, to an abstract data structure. Embedded hash values in turn offer a method to link the block chain to other data stores such as distributed hash tables that provides a look-up service that any participating node can efficiently retrieve the value associated with a given key. Once the transaction is confirmed, the document is permanently certified and proven to exist at least as early as the time the transaction was confirmed. If the document hadn't existed at the time the transaction entered the block chain, it would have been impossible to embed its digest in the transaction (This is because of the hash function's property of being second pre-image resistant. Embedding some hash and then adapting a future document to match the hash is also impossible due to the pre-image resistance of hash functions. This is why once the bitcoin block chain confirms the transaction generated for the file or tangible/intangible item, its existence is proven, permanently.

Due to the currently limited size of the block chain, a marker (unique ID number for the file or a unique private and public key) will have to exist until the community expands the bitcoin's block chain or we make our own for our own coin or cloned coin. The marker points to the files storage location, on a cloud location for example and uses the cryptographic keys of the block chain to release/transfer/retrieve the file from its storage area and send/delete it, etc. Delivery of said unlocking information for access (i.e. keys or ID's or doors or financial accounts) can uniquely be distributed over any computing device that incorporates PC's or Macs or Android/iOS apps and/or tablets or a wearable like BlueTooth. The “marker” and by default its private/public keys can now be shared. Best use would be for the user to keep the private key secret and use the public key to push this information to the user. The transportable “file” and its corresponding or traced “marker” (this marker points to a “file” peer to peer via digital currency cryptography systems already in existence or one we create). The “file” can also be posted to the block chain for full transparency as a general ledger mechanism; should one wish to confirm that their “file” is indeed on the block chain network. Using this method the date, time, and other respects of the data are recorded and no one can reverse that timestamp or ownership proof.

The net functionality is that tangible information is stored on the users storage/hardware medium or our software (web app, database, cloud) and is encrypted with virtual currencies cryptography of a private and a public key that the user transmits, at his/her will, to anyone as an authenticated user. The authenticated user brings it to an existing machine, kiosk, retailer, or security firm, that is legally permitted to reproduce the electronic file information.

The invention methodology permits the monitoring of the movement of the electronic file, in its secure form, using approved block chain cryptography for trace and track of that data.

The advantage of such an action of linking a file to a cryptocurrency is that ownership of the box within which the file resides is designed such that it behaves like a cryptocurrency from a cybersecurity standpoint. By way of example, the Bitcoin protocol is designed so that only the person who has the private key associated with a given bitcoin address can send funds from that Bitcoin address. Put another way, there is only one “owner” for a given (online service, public ID, user). Applying this framework and linking it by association to a virtual safe box held in a centralized database acts to protect the contents of that box with the same un-hackable cyber-security that is associated with the Bitcoin transfer protocol itself.

Because anyone can send Bitcoins to a given Bitcoin address, the original owner of the virtual safe box, can therefore provide access to the contents of that box to anyone in the public who has his/her own Bitcoin address. The owner of the account (held in cyberspace at a decentral or central database(s) of safe boxes) is given a cryptocurrency private and public key synonymous with the protocols of that particular cryptocurrency. Locking and unlocking said safe-box is done by means of the owner's public and private key information. Thus the contents of the safe box he/she owns can be managed in a trustworthy fashion. So by extension the file inside the virtual safe box associated with the cryptocurrency address can be established, confirmed, affirmed and transferred with un-hackable security and traceability.

The present disclosure leverages existing technology and computing infrastructure of Bitcoin or some other cryptocurrency with block chain protocol methodologies, including electronic Bitcoin-based transfer of ownership. It adds an action item that sidesteps potential issues of “block chain bloat” by means of a “marker” system described above. A Bitcoin address is an identifier of 27-34 alphanumeric characters, beginning with the number 1 or 3. The Bitcoin address associated with the “marker” acts as a public disclosure of the file that the “marker” points to. The micro- transaction entered on the digest of the Bitcoin block chain can be used to identify and track the transferred file. The Bitcoin address created by the user as a “marker” which points to the larger file of interest is identifiable with a public and a private key and user information. This is affected by making a request from the public Bitcoin API to generate this key pair. The owner, at his discretion and only when he desires may transfer his/her rights to this micro-Bitcoin currency unit “marker” into the Bitcoin address (which can also be referred to as a Bitcoin account).

The owner of the Bitcoin address or the address of some other cryptocurrency incorporating block chain protocol is by definition the owner of the “marker” which identifies him/her with the associated file of interest. When the owner decides to transfer the file he/she is the only one capable of transferring it by using the aforementioned keys associated with the “marker”. As ownership of the cryptocurrency account at issue can therefore be managed in a trustworthy fashion, by extension the file with which the “marker” is associated has its proprietorship managed in a trustworthy fashion. If and when the block chain is expanded or by using another method to accommodate for more bytes to be accepted with an OP_Return type function, the use of a marker will be abandoned and post the cryptographically locked contents or address directly on the block chain.

### BRIEF DESCRIPTION OF DRAWINGS

FIG. 1 shows an illustrative example of a schematic diagram of a system wherein sensitive information or a ‘marker’ to said sensitive information is embedded and linked to a cryptocurrency driven public and private key which can at some point in the future be transferred to a third party via block chain protocol in accordance with some embodiments of the disclosed subject matter.

FIG. 2 shows an illustrative example of a schematic diagram of a system generating a customer ID, submitting and storing information using block chain protocol embedding techniques for in accordance with some embodiments of the disclosed subject matter.

FIG. 3 shows an illustrative example of a schematic diagram of a customer interface system generating wherein the user is prompted by clickable icon choices for opening an account and creating cryptographic files.

FIG. 4 shows an illustrative example of a schematic diagram of a system allowing a customer to create a cryptographic file using block chain protocol embedding techniques for in accordance with some embodiments of the disclosed subject matter.

FIG. 5 shows an illustrative example of a schematic diagram of a system allowing a customer to lock his/her file or ‘marker’ for such a file in a block chain in accordance with some embodiments of the disclosed subject matter.

FIG. 6 shows an illustrative example of a schematic diagram of a system allowing a customer to send his/her file or ‘marker’ for such a file via transference of micro- quantities of crypto currency and block chain verification in accordance with some embodiments of the disclosed subject matter.

FIG. 7 shows an illustrative example of a schematic diagram of a system allowing a receiving party to gain access to the customer information at issue (be it for hardware produced physical production and/or delivery or simple transfer of sensitive data information) in accordance with some embodiments of the disclosed subject matter.

### DETAILED DESCRIPTION OF DRAWINGS

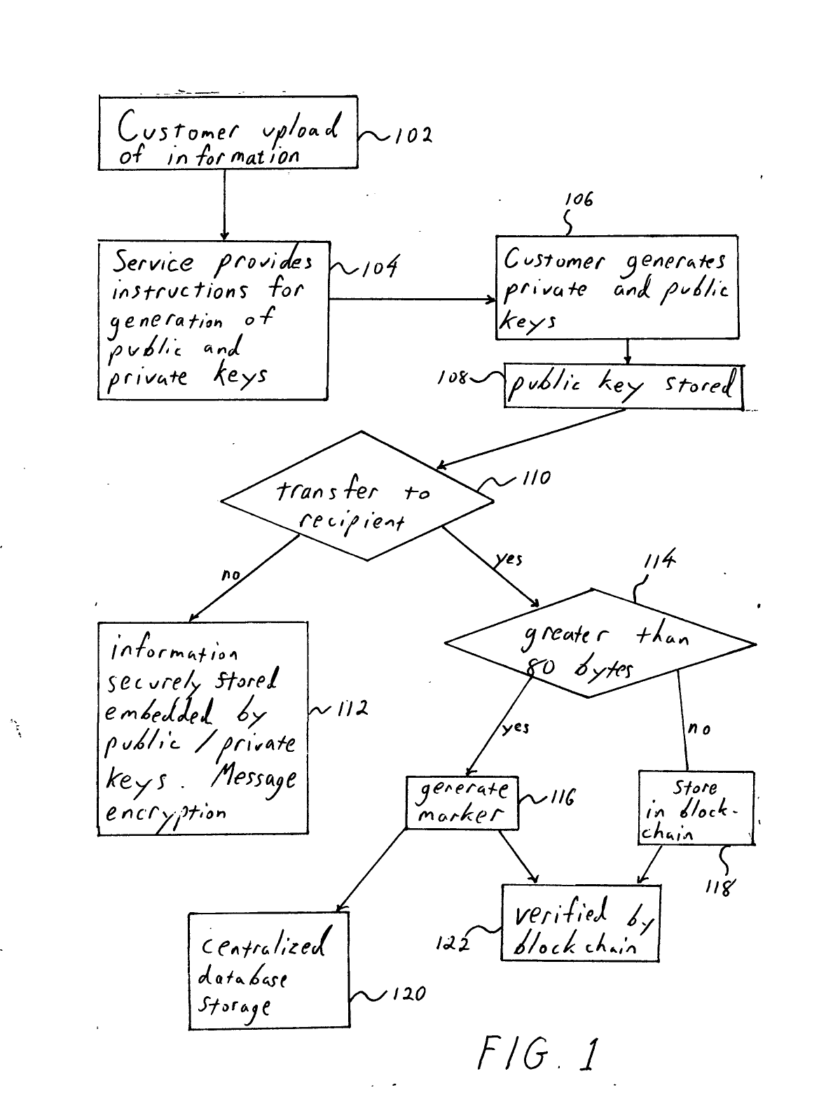

FIG. 1 shows an illustrative example of a schematic diagram of a system wherein sensitive information or a ‘marker’ to said sensitive information is embedded and linked to a cryptocurrency driven public and private key which can at some point in the future be transferred to a third party via block chain protocol in accordance with some embodiments of the disclosed subject matter. Customer uploads information 102 on the MyResQ web-service using a web-enabled device. The nature of this information is relevant only to the Customer. The MyResQ service is not privy to the contents of this information, the service then provides instructions for generating a public and private key 104. The public key is a verification key generated concurrently with the private key which is otherwise known as the signing key. Customer generates public key 106. The public key is stored in a centralized or cloud-based network purveyed by the administrator (MYResQ) 108. The generation of these concurrent mathematically related keys provides security for the information that the customer wishes to be kept secure. The information can be then kept secure by linking it to a public and private keys generated for what would otherwise be a crypto-currency micro-transaction. The sensitive information the customer has stored may then be kept stored for an indefinite period of time 110. So long as the customer keeps his/her private (signing) key secure, the information linked to the key will forever be kept cryptographically secure 112. Should the customer decide to transfer the securely stored information to a third party, then the customer would provide the input of a private and public key. Each time the customer decides to unlock and securely transfer his/her information then a separate request is given to the block chain. The MyResQ server shall determine whether the information the customer wishes to transfer is greater than or less than 80 bytes 114. If it is greater than 80 bytes then a ‘marker’ is generated 116 directs the process to a centralized or decentralized database 120. This is done in order to make sure that information stored on a block chain is not too great as to strain the capacity of storage available on the medium. If it is smaller than 80 bytes then the information is stored directly on the block chain 118. Thus, upon block chain verification 122 the intended third party is given a transfer of an insignificant amount of crypto-currency from a monetary standpoint, but the sensitive information linked to the transfer is made as well. FIG. 1 describes a method wherein the customer's file is uploaded and locked in the block chain and thus is given a block chain ID. Any subsequent call-out for retrieval of the file at issue must be done via the block chain protocol. This is how piece of sensitive information is “loaded and locked” for subsequent secure transfer to one's self or a desired third party transferee.

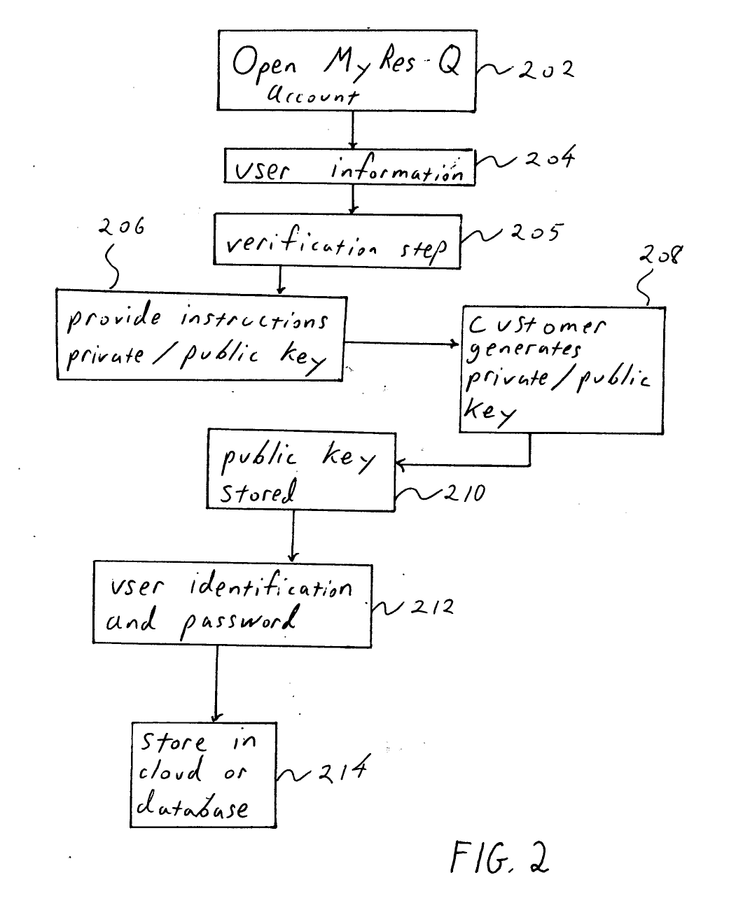

FIG. 2 shows an illustrative example of a schematic diagram of a system generating a customer ID, submitting and storing information using block chain protocol embedding techniques for in accordance with some embodiments of the disclosed subject matter. Here the customer goes to any web-enabled device, logs into the MyResQ landing page and is prompted to open an account 202. He/she must then provide his/her user information 204. Such information is not unlike the information needed to open a standard Bitcoin wallet such as is available on the market today (e.g. Coinbase). Upon receiving said information the service shall undergo a verification step 205 wherein such entries are audited and vetted for their authenticity. MyResQ provides standard instructions for the generation of a public and private key 206. The crypto-currency functionality wherein transactions are independently verified, peer-to- peer and via block chain protocol is strictly adhered to, thus the service provider middleman has no ability, access or other such right to the information which is linked to the customer generated public and private key 208. The public key is stored in the user's account 210. A user ID and password is generated in order for the user to access and open his account information for future use 212. The information (kept locked by public/private keys) is kept in a cloud based decentralized storage space or in a central database 214.

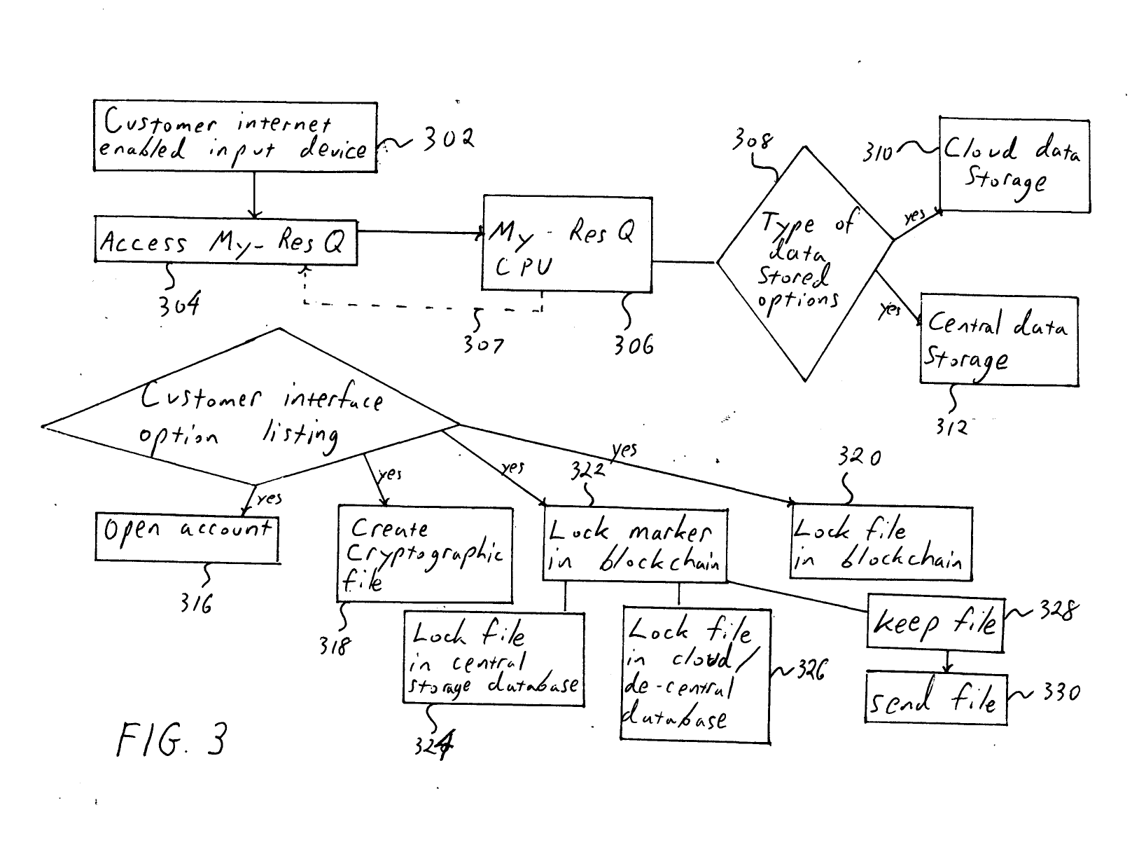

FIG. 3 shows an illustrative example of a schematic diagram of a customer interface system generating wherein the user is prompted by clickable icon choices for opening an account and creating cryptographic files. A customer may log onto MyResQ using any internet enabled device 302. He/she accessed the MyResQ landing page 304. The MyResQ cpu 306 evaluates the type of data stored 308. The MyResQ cpu creates a user experience 307 configured to interact and respond to customer inputs 302 on the landing page 304. The cpu 306 then determines (based on the nature and size of the information that is being stored) whether the information is to be stored in a cloud-based system 310 or at a centralized location 312. Meanwhile the customer is prompted to make decisions on the interface screen itself. The customer is asked “what would you like to do?” 314. He/she is then prompted to make a decision regarding creating an account at MyResQ 316 creating a cryptographic file 318 (i.e. information to be stored using the generation of a public and private key linked to the block chain either directly or by means of ‘a marker’). We define “marker” as the unique process, in which, a cryto-currency block chain stores and manages cryptography keys, which is verified by a community of miners that are incentivized to confirm the transactions. This “marker” is unique to that particular “file” and its corresponding timestamp information cannot be changed once it is recorded on the block chain. If one uses additional existing cryptography methods (described later), in conjunction with virtual currencies existing block chain technology, it is even harder to hack. Almost impossible. Again, it is important to remember for file sizes that can be posted directly to the block chain because they meet the current limit capacity, we will post those directly.

The cpu 306 determines whether the information is locked directly on a block chain 320 or if a marker to that information is stored on the block chain 322. If the answer is the latter then the information itself (linked to the block chain only via the ‘marker’) is locked in a centralized storage database 324 or in a decentralized cloud-based database 326. The customer may then choose to keep the file 328 or send the file to a third party or to the MyResQ server for further processing 330. Sending a file may be done using input measures that occur at the independent discretion of the customer. Or the customer may choose that that his/her information upload be pre-determined to automatically release upon the occurrence of a particular event. For example a geo- fencing feature in a software program that uses the global positioning system (GPS) or radio frequency identification (RFID) to define geographical boundaries may trigger a release of the sensitive information as soon as the a vehicle, an object or a person breaches or enters the barrier.

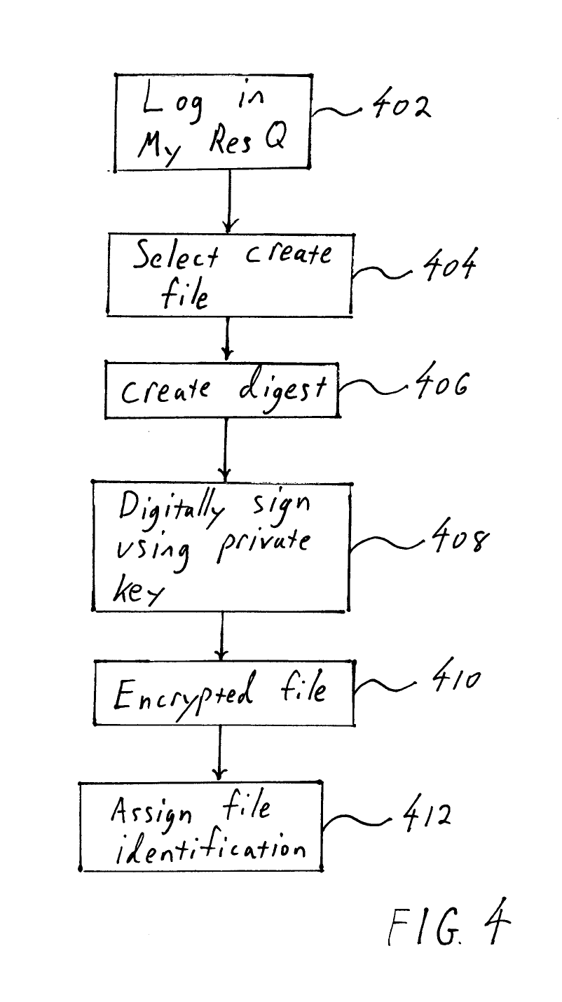

FIG. 4 shows an illustrative example of a schematic diagram of a system allowing a customer to create a cryptographic file using block chain protocol embedding techniques for in accordance with some embodiments of the disclosed subject matter. The customer logs into MyResQ using any web enabled device 402. He/she may then choose to create a file 404 whose contents is greater than 80 bytes. The file created may be any of a wide variety of official, non-official, 3d printable instrumentation described above. Examples include but are not limited to physical keys, bearer instruments, trademarked and/or copyrighted artist generated forms of expression, title deeds, legal documents, university transcripts, codes, passwords, any and all information reproducible materials. The system then creates a digest 406 wherein a message is “hashed” and through this process becomes “non-invertible” due to the avalanche effect. Non invertible means one cannot duplicate the private or public keys with only one known. Further complicating things for hackers is the avalanche effect. The avalanche effect states that upon small changes in the input, very large changes in the output take place and vice versa, rendering a circle effect that can never be solved. Theoretically, without collision of hashes, the information is not hackable.

Upon creation of a digest 406, the customer may then verify the message on the block chain using his/her secure private key 408. This is then verified by means of a public key and the file is encrypted 410. “Proof of existence” shall be used for MyResq's process of encryption, but at times will use “proof of work”. Proof of existence is as follows: Once the information is scanned or in other manners, typed into the software we provide for storage, we put this information into a cryptography digest or hash. A cryptography digest is essentially a really long string of unreadable numbers and letters. That hash represents that a file has been presented to the block chain, but not the actual contents of the file; thus not the file itself. Alternatively, one can put the actual contents of the file onto the block chain, if they so desire it to be transparent to all. When the same file is presented again, the same marker is created and provides for verification that the “files” are the same. If the “file” has changed, the new marker will not match previous markers—that is how the verification is ultimately achieved. This digest is then posted to the block chain and is entirely transparent and searchable upon different factors. This process allows for cryptography and one can later certify the data existed at the exact time one posted it, as well as, any changes or movements. The scripting abilities of a digital currency's block chain allows for transactions to have no output. This means that while a small amount of, in this example Bitcoin, goes into the system as a fee for miners to confirm the transaction(s) within a block, no actual BTC needs to be sent to the recipient. This avoids money transfer regulation, entirely for our purposes. So the block chain has the built in functionality for miners to stay engaged and the transactions are confirmed.

MyResQ shall assign a file ID 412 to the customer upon completion of the cryptocurrency driven encryption process.

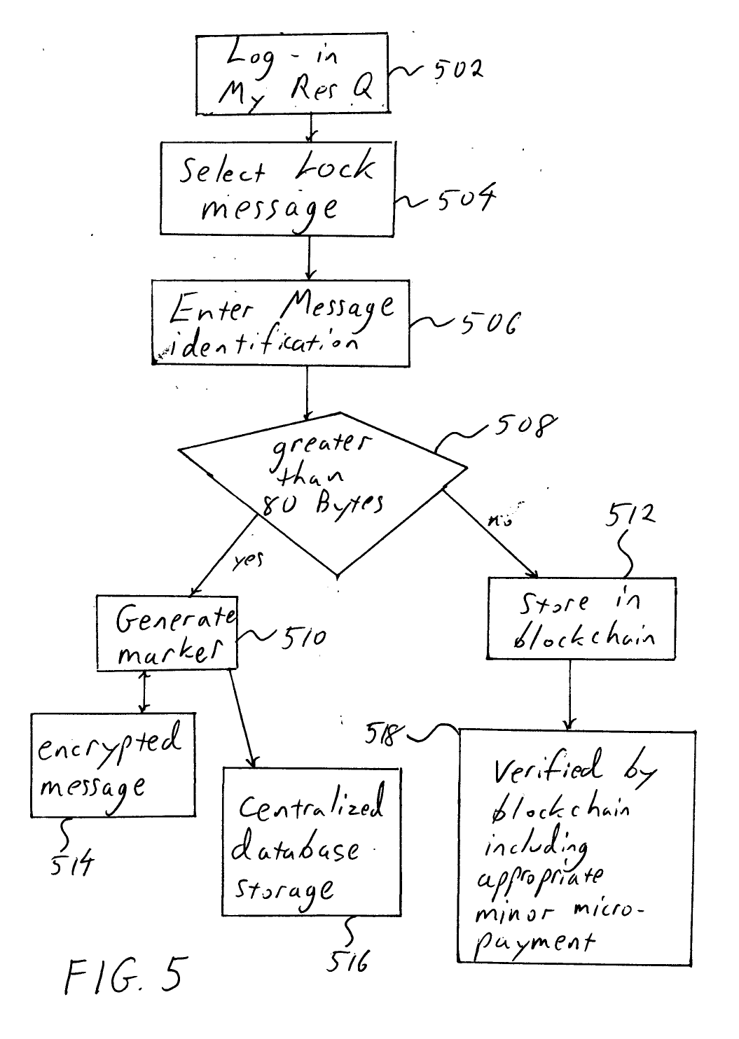

FIG. 5 shows an illustrative example of a schematic diagram of a system allowing a customer to lock his/her file or ‘marker’ for such a file in a block chain in accordance with some embodiments of the disclosed subject matter. The customer logs into MyResQ using any web enabled device 502. Customer selects “Lock Message” on his/her My ResQ account interface 504. The hardware and software will read a digital computing file that allows for virtual currency cryptography to lock and un-lock this stored information inside its “file”. This file and its owner's variables can be stored directly on the block chain. For larger files we will use a “marker”, posted to the block chain, that then points to the files storage location, on a cloud/internet/mobile, etc., and use the cryptography keys of the block chain to release/transfer/retrieve the file from its storage area and send/delete it, etc. The customer then enters his/her Message ID 506. This message is authenticated by means of standard digital signature technology. If the contents of the information of the message is greater than 80 bytes 508 then a ‘marker is automatically generated 510. MyResQ shall encrypt the message 514 linked to the marker by means of the aforementioned encryption process assign a file ID to the customer upon completion of the cryptocurrency driven encryption process (digital signing key plus public key verification). The information the marker points to shall be kept in a centralized storage database 516. Because the OP_Return/UTXO transaction scripts are currently limited to 80 bytes, MyResQ shall approach the pushing or sharing of files in two ways a) with the “marker” to the file scenario and b) directly posting to the block chain as many bytes that can currently be handled by the block chain now. If the information of the message is less than 80 bytes storage is made directly on the block chain 512. In either case the marker or the file or the message itself is stored on the block chain 512. Using the block chain to trace and track and share, make private and allow user total control over their data with smaller files can be directly posted to the block chain. With larger files there exists “a marker” (process explained below by OP_Return/UTXO) and manage private/public keys on the block chain with a peer to peer transparent ledger. The micro-transaction is the verified by the block chain protocol 518.

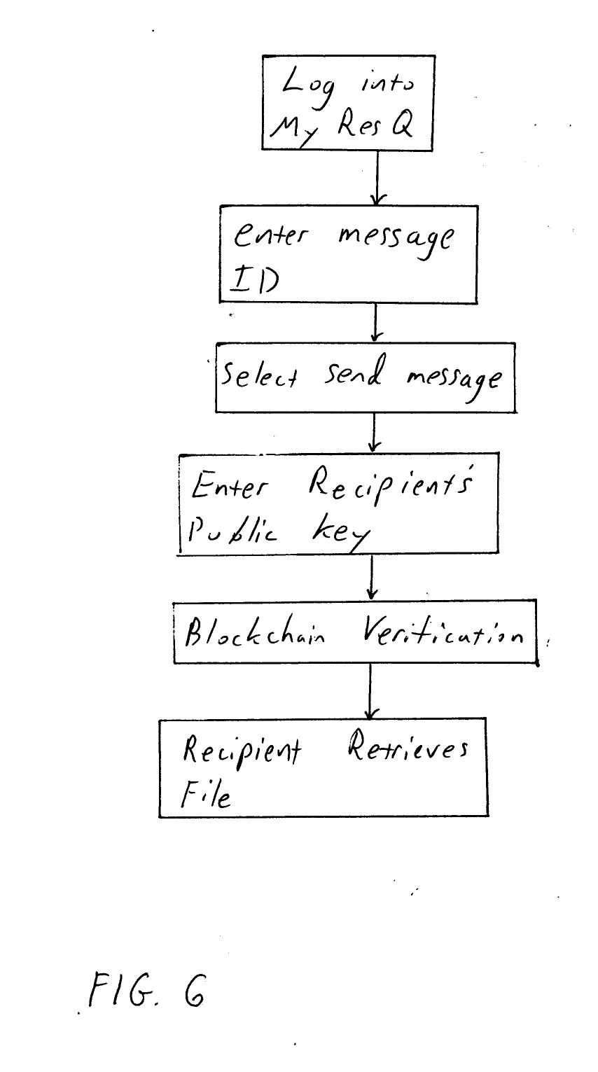

FIG. 6 shows an illustrative example of a schematic diagram of a system allowing a customer to send his/her file or ‘marker’ for such a file via transference of micro- quantities of crypto currency and block chain verification in accordance with some embodiments of the disclosed subject matter. The customer logs into MyResQ using any web enabled device 602. The message ID is then entered 604. This message is authenticated by means of standard digital signature technology. The customer may use the interface to select his/her message of choice 606. Customer enters recipient's public key 608. Typically the recipient will be a member of MyResQ as a user or has his or her own synergistic cryptocurrency wallet so that he/she has his/her own public key. The insignificant micro-transaction is verified on the block chain 610. The significant aspect of this transaction is that it is linked to the file to be transferred or a marker to the file to be transferred. The recipient receives the insignificant cryptocurrency denomination along with the file itself or the marker which points to the file at issue 612.

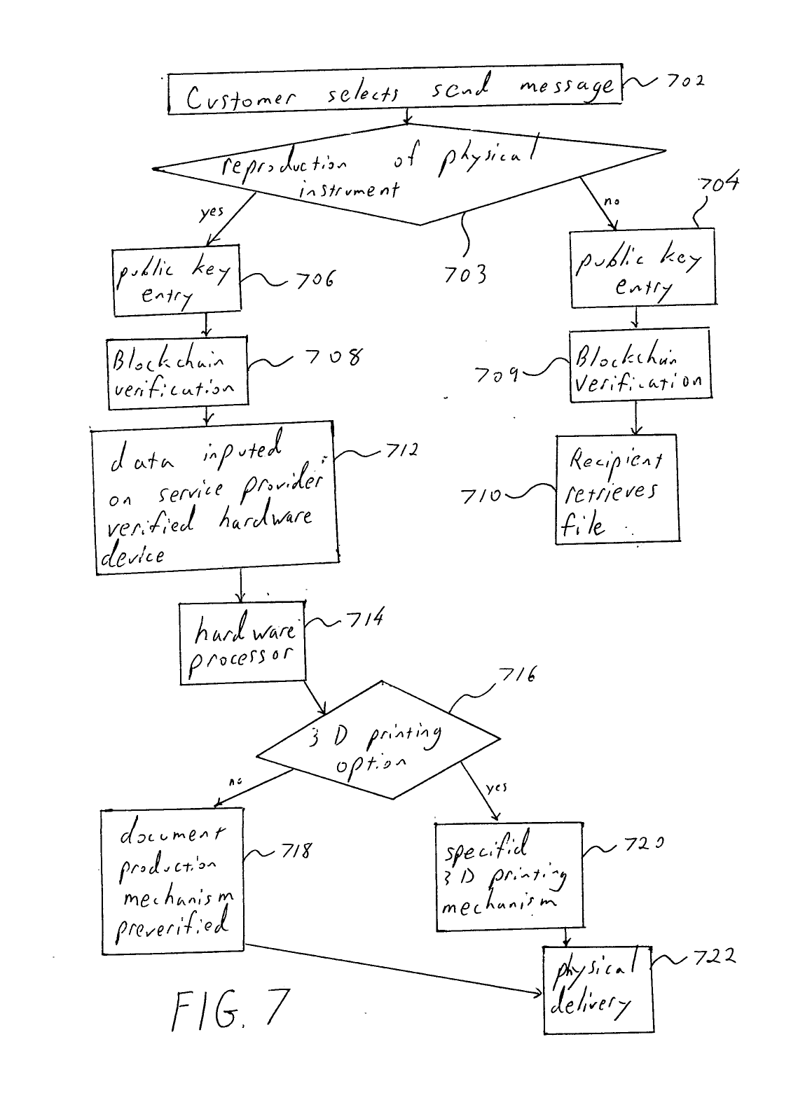

FIG. 7 shows an illustrative example of a schematic diagram of a system allowing a receiving party to gain access to the customer information at issue (be it for hardware produced physical production and/or delivery or simple transfer of sensitive data information) in accordance with some embodiments of the disclosed subject matter. After the customer selects “send message” 702 the message or marker to the message is sent to the recipient by using the standard block chain protocol functionalities described above. The customer may choose to receive (or for the selected recipient to receive) a physical manifestation of the block chain incorporated cryptographically secured and saved information. The information stored on the block chain or stored elsewhere but marked on the block chain can be reproduced in some tangible fashion based on the nature of the information itself 703. The information may be for a 3D printing, it may be a picture of a physical key for reproduction. It may be some official instrument such as an original transcript or a title deed (see examples of various instruments described above in the background to the invention). Should the customer choose physical reproduction option, he/she must enter the recipient's public key 704. This triggers the bitcoin protocol and subsequent block chain verification 709. The recipient may then retrieve the file just at the point where he/she retrieves the insignificant micro-payment of cryptocurrency 710. Should the customer not choose a physical reproduction option, then he/she may simply enter the recipient's public key 706 and allow for the cryptocurrency micro-transaction to fulfill the transfer of the stored and cryptographically secured information. The transaction is then verified by block chain protocol 708. The data that is produced is subsequently inputted into a service provider verified hardware device 712. The device is outfitted with a processor 714 which receives the input. Optionally the recipient may be MyResQ itself and the file may then be stored under traditional security means purveyed by standard cloud and central database security measures.

Should the customer choose to reproduce a physical instrument from the file that was initially cryptographically secured on the block chain (or via a marker on the block chain pointing to a central or decentral area of storage of the larger that 80 byte file), the data upon block chain verification 708 may be reproduced by the newly acquired information given to the recipient. Data acquired through the block chain verification process may then be inputted into a verified hardware provider 712.

For instance, a recipient may be a family member or a friend or some official representative entrusted to create a hard reproduction of the information received. Or the recipient may be MyResQ itself which may then escort the information to a verified hardware device capable of reproduction in hard form of the received information. MyResQ may for instance then send the information to a verified hardware device in the location of the customer's choosing. It may be prompted to send the information to a hardware device-based upon pre-determined customer approved GPS and/or geofencing technology inputs. Upon receipt of the input, hardware processor receives security information from a user (in this case a 3rd party recipient or the MyResQ service provider depending upon the choice of the customer); and receives information about a tangible, reproducible instrument associated with the security information received by means of cryptographically secure block chain protocol; and reproduces a hard copy based upon such information. Once the 3D printer receives the sensitive collected data, the process of 3D scanning is initiated. Data is analyzed and the collected digital data on the shape and appearance of a real object is gathered and processed. Based on this data, three-dimensional models of the scanned object can then be produced. The types of modelling provided in the present invention are in keeping with standards and norms in 3D modelling software currently on the market.

Regardless of the 3D modelling software used, the 3D model (often in .skp, .dae, .3ds or some other format) then needs to be converted to either a .STL or a .OBJ format, to allow the printing (a.k.a. “CAM”) software to be able to read it.

The Customer may choose to have a 3D printing created from the information which was cryptographically secured and sent via block chain protocol 716. The verified hardware device 712 (in this case a 3D printer) and hardware processor 714 reproduce a tangible 3D printed product by means of a specified 3D printing mechanism 720. This product may then be delivered 722 upon instruction and by any means currently available by man or may be available in the future.

Examples of such means are regular mail, physical rush delivery by a professional courier, medical professional, GPS enabled location-based tracking, drone technology or any other means potentially available under the sun. Should the customer not choose a 3D printing, then the verified document production mechanism 718 of the customer's choosing may be enlisted to reproduce a hard copy of the cryptographically stored and secured block chain verified information.

1. A system for securely storing and transferring title to an instrument securely, the system comprising a peer to peer crypto currency block chain type network configured to:
Encrypt a digital file of the instrument by means of secured public and private keys;
create an encrypted digital file of the instrument using hash functions;
provide public and private keys unique to the owner;
provide authentication by independent confirmation via a peer to peer cryptocurrency block chain type network;
provide storage for the encrypted file; and
provide the digital file information to the intended receiver at the sole discretion of the owner; whereby the digital file information is private, secure and non-hackable.

2. The system of claim 1 wherein the peer to peer crypto currency block chain type network is the bitcoin network.

3. The system of claim 2 wherein the bitcoin network is further configured to allow private and public keys to act as markers within the network which act to identify a virtual safe box whose contents include by association a way to point to a file greater than 80 bytes.

4. The system of claim 3 wherein the marker is an infinitesimally small micropayment such that it create a footprint of the file that is insignificant from a monetary standpoint but acts to link the transference of information located within the file in a manner that equates it to standard practices of the bitcoin protocol.

5. The system of claim 4 wherein the receiver receives the insignificant cryptocurrency denomination along with the file itself or the marker from the owner at the discretion of the owner.

6. The system of claim 4 wherein the bitcoin protocol further configured to allow for the owner and the intended recipient file transfer to be verified within the peer to peer crypto currency block chain type network by means of an appropriate micro-payment

7. The system of claim 1 wherein encrypted digital files 80 bytes and smaller are stored directly in the block chain for independent confirmation via a peer to peer crypto currency block chain type network.

8. The system of claim 1 wherein the instrument is stored optionally in a cloud based decentralized storage space or in a central database.

9. The system of claim 1 wherein the owner has access to secured public and private keys by means of internet enabled computer readable owner identification and password based systems.

10. The system of claim 1 wherein the hash functions are further configured to create a non-invertible digest.

11. The system of claim 1 wherein the digital file is encrypted and secured to adequately support a wide variety of official, non-official, and 3d printable instrumentation.

12. The system of claim 1 wherein the storage for the encrypted file is further configured to allow the owner to input the file in a standard username and password accessible web enabled device wherein the file can thereafter be locked directly in a block chain or alternatively as a marker in a block chain.

13. The system of claim 11, further comprising one or more sets of instructions for the owner to enable encryption of the transcripts on the web enabled device interface.

14. The system of claim 12, wherein the digital file is configured in a manner which allows the central database network to associate the stored file with the identity of the owner.

15. The system of claim 1, further comprising one or more devices configured to at least enable viewing of the instrument by the owner, wherein
the instrument corresponds to information which is securely encrypted by the peer to peer crypto currency block chain type network, wherein
the owner chooses the manner by which to receive a physical manifestation of the block chain incorporated cryptographically secured and saved information;

16. The system of claim 15 wherein the owner chooses to have a selected third party receiver receive a physical manifestation of the block chain incorporated cryptographically secured and saved information.

17. The system of claim 15 wherein the one or more devices is a remote activated 3-D printer configured to receive information and output a physical object at an owner specified location and specified time.

18. The system of claim 15 wherein the one or more devices is a remote activated standard printer configured to receive information and output standard information in ink generated form at an owner specified location and specified time.

19. The system of claim 16 wherein the receiver may be a secure centralized or cloud-based network designed to store the instrument under traditional internet and computer enabled security means.

20. A method of securely storing and transferring title to an instrument securely, the method comprising, creating an encrypted digital file of the instrument secured by private and public keys;
creating an encrypted digital file of the instrument using hash functions; providing private and public keys unique to the owner;
providing authentication by independent confirmation via a peer to peer crypto currency block chain type network;
providing storage of the encrypted file; and
providing the digital file information to the intended receiver at the sole discretion of the owner; whereby the digital file information is private, secure and non-hackable.
